(19) United States
(12) Patent Application Publication
(10) Pub. No.: US 2017/0334352 A1
(43) Pub. Date: Nov. 23, 2017

(54) ROAD EFFECTS MIRROR COVER

(71) Applicant: FLOYD EMMANUEL JOHNSON, COLUMBIA, SC (US)

(72) Inventor: FLOYD EMMANUEL JOHNSON, COLUMBIA, SC (US)

(21) Appl. No.: 15/530,795

(22) Filed: May 2, 2016

(51) Int. Cl. B60Q 7/00; B60Q 7/02

(52) U.S. Cl. CPC B60Q 7/005; B60Q 7/02

(57) ABSTRACT

To date millions of vehicles travel interstate roadways and highways with little safety mechanisms for motorists outside the vehicle on new and used passenger vehicles. The passenger vehicles have little protection and/or protective devices for the motorists outside the vehicle. I am not advocating motorists to get out of their cars however I am advocating safety for all motorists to understand and give all travelers the best safety environment for all. Noticing an increase in fatalities on roadside emergencies due to distractions, low light, dusk and dawn setting makes this product an asset for safety. Utilizing the road effects mirror cover invention to help communicate your space and create awareness for others to see you is the best way to increase safety in day and night conditions. The intention of the invention is to symbolize awareness no different than a marker on a bridge way or roadway, or managing your vehicle between the lines. In both active and non-active roadside events when motorists are aware of a vehicle or person stranded it gives everyone the best safety practice possible. The road effects mirror cover will highlight lives in the best possible way so all parties can complete their travel to their destination on short and long distance travel. In summary, the road effects mirror cover and features can make safety a lifestyle for travel and save lives.

### BACKGROUND OF INVENTION

A number of innovations for roadside safety have been provided in prior patents that will be described. Although these innovations may be suitable for specific individual purposes to which they address, they differ from the present invention. The invention purpose is not to communicate any indicia to be read, it solely is to symbolize awareness and presence of being on the roadside or any circumstance traveling can place us. (Note: Emergency vehicles with lights request drivers to switch lanes) This invention is to increase awareness where a traveler can be outside the vehicle.

The present invention highlights the driver or persons traveling in the vehicle with personal indicia outside the vehicle changing a tire or stopped to give other motorist support. It gives a form of resolution to lowering or eliminating a growing number of accidents on the roadside during evenings, dusk and dawn settings to no light or no visibility. During daylight it creates high visibility with indicia to separate you the distressed driver and your car from a high level of moving traffic. The invention helps increase the reaction time for a driver to bring vehicle to a complete stop while sorting through the chaos on the roadway. This application is an improvement to prior inventions and disclosure found in each of the following patents.
US Patent: US2015/0054660A1 Simmons, Feb. 26, 2015
Portable Sign used to protect stalled or broken down vehicles with passengers still on board to prevent oncoming vehicles or traffic from colliding with the stalled vehicles.
U.S. Pat. No. 8,146,278B1 Grant, Apr. 3, 2012
Illuminated Flag invention is directed to an illuminated display configured for mounting to an automobile flag pole, or alternately, to a window. The display panels can include any number of indicia including messages or logos.
U.S. Pat. No. 6,112,443 Stubbs, Sep. 5, 2000
A display device to discourage the summoning of an emergency response in a display support positional near an emergency site.
U.S. Pat. No. 4,091,553 Gleannie, May 30, 1978

Emergency Display Apparatus and Methods of Constructing and Utilizing Same

A display apparatus for use by stranded motorist in an automotive vehicle which employs pictorial representation to convey passing motorist the nature of an emergency distress condition. The application includes a plurality of sign members having pictorial representations displayed thereon which correspond to distress conditions such as medical problems, fuel problems, and need for a tow truck.
U.S. Pat. No. 3,738,039 DeFuria Jun. 12, 1973
Highway Safety Aid invention relates to highway safety aid for use with automobiles, boats, trailers, and the like in which the safety aid is fitted over an edge of a glass window, or the like, and has an arm extending outwardly for receiving a sheet of flexible material on which characters or indicia are disposing for constituting an emergency sign.

### DRAWING DESCRIPTION

A mirror cover distress safety aid used to protect motorist traveling the highway with apparatus attached to a motor vehicle or motorist body for safety. The cover is comprised of multiple applications used to create awareness in day and night travel. The invention is relatively about having the tools needed to complete your travel or be of assistance of saving a life.

### DESCRIPTION

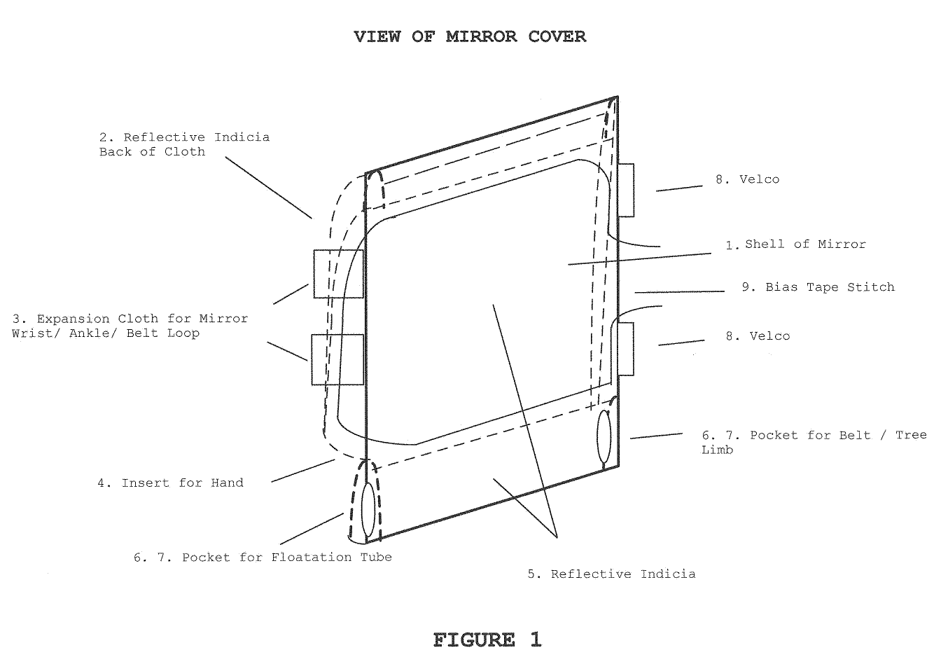

FIG. 1
1. Shell of side view mirror.
2. Reflective indicia on back of cloth covering side view mirror.
3. Removable Expansion cloth to be used as additional safety features ankle, wrist, and belt loop attachment for visibility away from vehicle if needed.
4. Bottom of device can be used as a pocket to insert hand to create signal if needed.
5. Reflective indicia on Reflective Material(High Visibility at Daylight; Reflective Visibility at Night)
6. Versatile Hole Insert to create marker from a tree, flag pole, or any item on vehicle
7. Versatile Hole Insert for Foam Tube (removable) now making the device a floating high visibility/reflective marker in water
8. Velcro Flaps to secure cover
9. Bias Tape Stitched around the cloth for finished touch

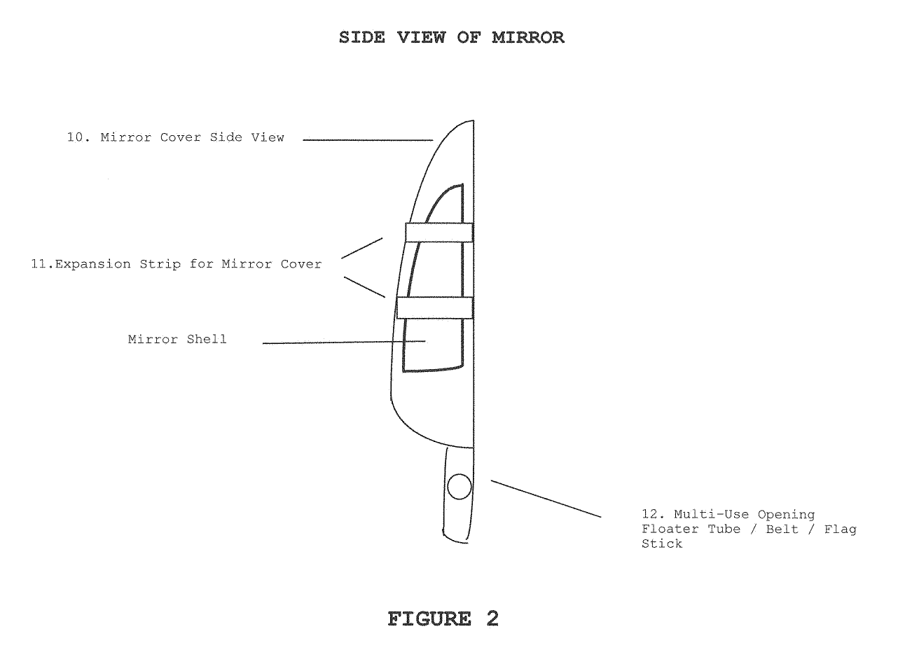

FIG. 2
10. Side View of Application on Mirror
11. View of Expansion Strip for Mirror Cover
12. Opening For Foam Tube (Removable), Belt, Flag Stick, Tree Limb etc.

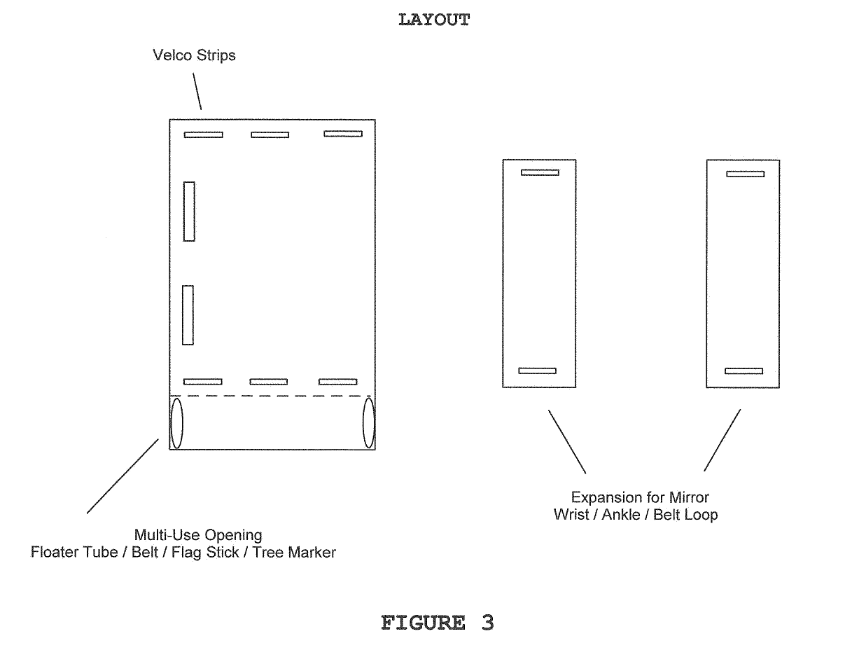

FIG. 3

A virtual layout to show what the cover looks like inside. The cloth layout will measure and stitch with bias tape around the top and two side edges. At the bottom of the cloth a fold would be made to create multi-use opening. Along the inside of the layout Velcro strips will be applied to cloth as highlighted.

Two expansion cloths are cut to measure with bias tape stitched around all edges. The edges will be uniformly stitched to match the cloth layout. Along the layout Velcro strips will be applied to cloth as highlighted.

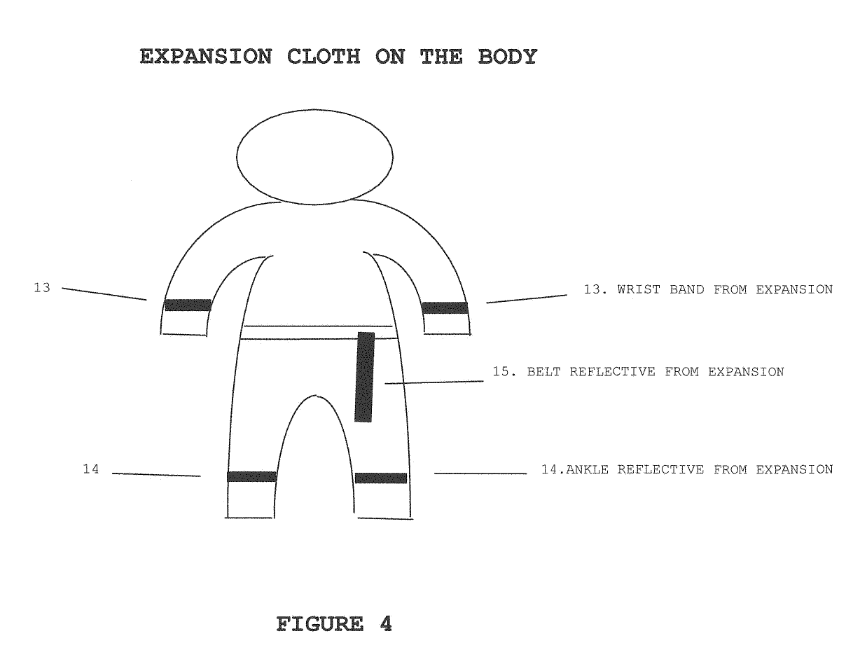

FIG. 4

A virtual layout of the Expansion Strips method of claim material creating a safety apparatus on the moving body of the motorist if needed outside the vehicle. The expansion can be used on the 13) wrist 14) ankle and/or 15) belt loop to create safety awareness in day and night travel.

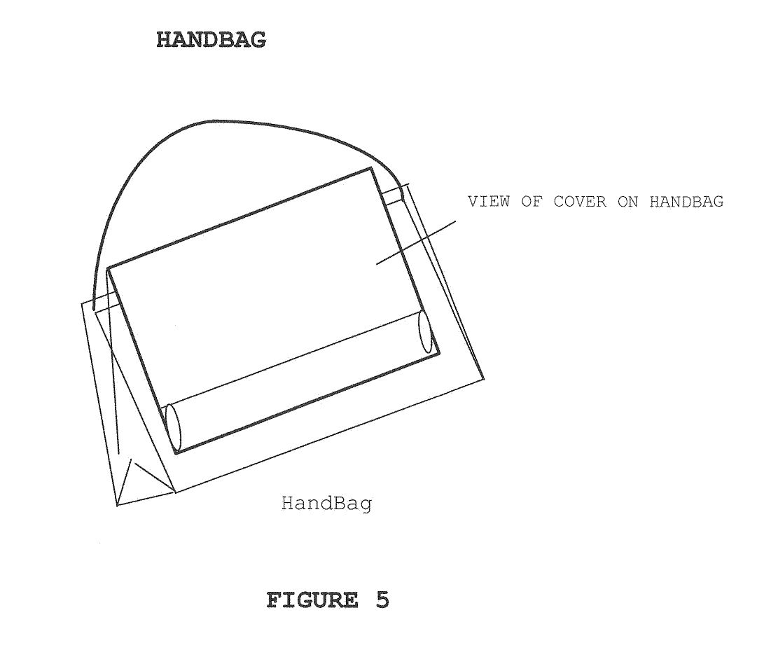

FIG. 5

A view of a handbag with the cover method of claim placed over the bag creating a safe view for anyone traveling or moving outside a vehicle or on a crowded street. This feature is also great for pedestrians moving in business and social settings that have heavy traffic. Great for handbag, book bag, attaché carry bag, etc. . . .

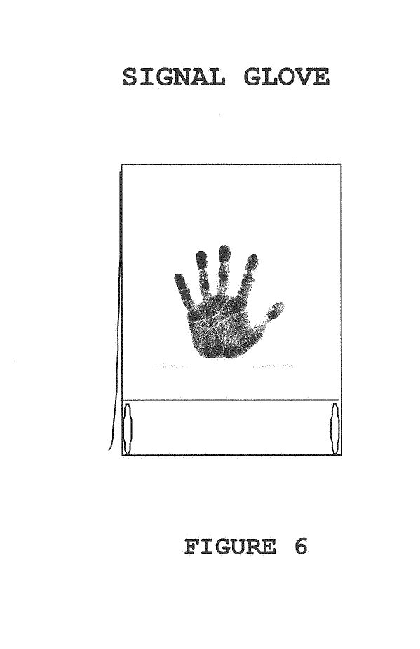

FIG. 6

A view of the mirror cover method of claim 1 converting to signal device with both sides closed with velcro. This allows the user to insert hand through the bottom of the cover pocket in turn creating a glove like experience.

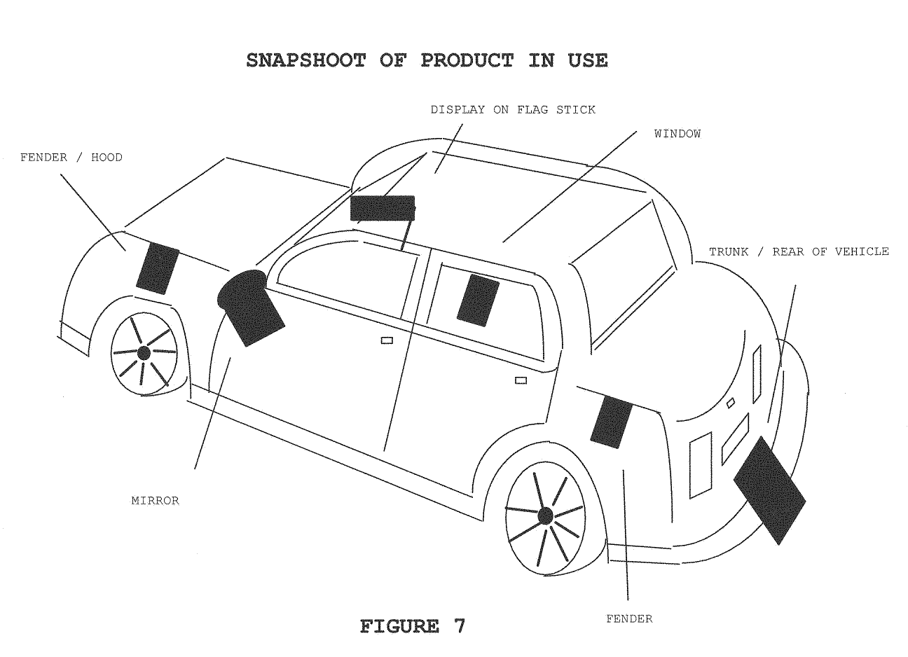

FIG. 7

A snapshot view of the claim application in use on a vehicle. The highlighted areas only reflect but do not limit application use.

REFERENCES:

| D 692,821 | November, 2013 | Lyan, et al. |
|---|---|---|
| D 653,192 S | January, 2012 | Lewis |
| 2012/0154911 | June, 2012 | Huynh |
| D 633,029 | February, 2011 | Stephanis, et al |
| D 633,430 | March, 2011 | Stephanis, et al. |
| D 636,325 | April, 2011 | Marsh |
| D 550,457 | September, 2007 | Schlegel |
| 2004/0238088 | December, 2004 | D'Andrea |
| 6,325,121 | December, 2001 | Hundnall |
| D 418,930 | January, 2000 | DeLeon |
| 3,738,039 | June, 1973 | DeFuria |

1. Road Effects Mirror Cover, a safety display used as a safe view protection for the driver of the vehicle and other traffic approaching distressed vehicle. The display creates awareness for the driver as a signal outside the distressed vehicle with multiple applications for placement on the vehicle or application on the driver or passenger body. The application demonstrates practical use for multiple and interchangeable use based on vehicle or body of the driver. The safety display marks all the concerns for travel to mark your presence and survival for various conditions. Whether marking a tree for a vehicle off the road accident or placing application on vehicle in the snow or overturned vehicle the product increases your chances of being located by emergency response in day and night travel. The product also promotes safety awareness in water conditions with foam floatation to keep the safety aid above water.

2. Road Effects Mirror Cover Expansion Cloth used as body reflector demonstrating movement outside the vehicle on body.

3. Road Effects Mirror Cover used as interchangeable device on vehicle body, hand bag, and or signal device.
